(19) United States
(12) Patent Application Publication
(10) Pub. No.: US 2011/0132140 A1
(43) Pub. Date: Jun. 9, 2011

(54) Transmission structure of meat tumbler

(76) Inventor: Sheng-Nan Guo, Chung Buu Shiang (TW)

(21) Appl. No.: 12/591,964

(22) Filed: Dec. 7, 2009

(51) Int. Cl. F16H 37/00

(52) U.S. Cl. 74/640

(57) ABSTRACT

This invention relates to a transmission structure of meat tumbler, in which one end of drum's axle, extending toward a control box, of the meat tumbler is assembled with a gear, and a reduction machine is installed in the control box. A gear of the reduction machine meshes with the gear of the drum. A motor coupled to the reduction machine is provided within the control box. Essential benefits such as quiet operation process, effective power transmission, and prevention of improper parts stripping can be achieved by this stable transmission structure.

### BACKGROUND OF THE INVENTION

1. Field of the Invention

The present invention relates to a transmission structure of meat tumbler, more particularly to a transmission structure in which a motor directly drives a reduction machine, and in turn the reduction machine directly meshes with a gear of drum.

2. Brief Description of the Prior Art

Meat product such as chicken, pork, beef usually is conducted with meat preprocessing before processing treatment so as to raise mouthfeel of processed meat after cooking. Common method of meat preprocessing uses meat grinder to destruct fibers of meat. However, in the process of treatment by meat grinder, a considerable quantity of muscle cells of meat is also destructed such that nutrition of meat is flowed away. Thus, a method has been proposed to raise toughness of meat by either mincing or beating, flinging, batting the surface of meat so as to raise mouthfeel of meat after cooking. However, the method of mincing, beating, flinging, or batting meat manually needs a lot of strenuous effort and time, and often fails to meet huge quantity demand of meat especially in meat market. Hence, relevant industries have actively developed a meat tumbler that can massage and tenderize meat products.

Referring to FIG. 4, a conventional meat tumbler (5) is essentially provided with a drum (51). A chainwheel (53) is assembled on one end of an axle of a drum (51) extending out of a control box (52), and another chainwheel (55) is assembled on the drive shaft (541) of a motor (54). A chain (56) is wound around these two chainwheels (53), (55). In this manner, when the drum (51) is rotated, meat received in the drum (51) is tumbled by the guiding of propeller blades mounted on the inner surface of the drum (51) and by repeatedly raised and dropped actions caused by rotation of the drum (51) so that meat product can achieve good mouthfeel effect with freshness and deliciousness after cooking.

However, in operation, this conventional meat tumbler (5) utilizes motor (54) to rotate the drum (51) through the chainwheels (53), (55) and the chain (56). In this mode of transmission, the chain (56) is prone to be worn out and to be stretched longer after a long period of time usage so that good fitting between the chain (56) and the chainwheels (53), (55) gets worse and produces loose. In this case, the running of the chain (56) and the chainwheels (53), (55) generates significant noise, even results in considerable power loss. Moreover, the chain (56) might be stripped from the chainwheels (53), (55) when in running.

In view of the above shortcomings of prior art, the inventor of the present invention proposes an improvement on transmission structure of conventional meat tumbler based on his proficient experience and knowledge in R&D and manufacturing in relevant field, with a purpose to achieve better practical value of the invention.

### SUMMARY OF INVENTION

The main object of the present invention is to provide a transmission structure of meat tumbler that can avoid improper power loss, abnormal noise in operation and loose or stripping happened between parts during usage.

In order to achieve above object, a transmission structure of meat tumbler is provided, in which one end of an axle of a drum extending toward a control box is assembled with a gear, and a reduction machine is installed in the control box, a gear of the reduction machine meshing with the gear of the drum. A motor coupled to the reduction machine is provided within the control box.

In this manner, essential benefits such as quiet operation process, effective power transmission, and prevention of improper loose or stripping between parts can be achieved by this stable transmission structure.

### BRIEF DESCRIPTION OF THE DRAWINGS

FIG. 1 is a perspective view of the present invention.

FIG. 2 is a side view of the present invention.

FIG. 3 is a view showing the present invention in use state.

FIG. 4 is a side view of a prior art.

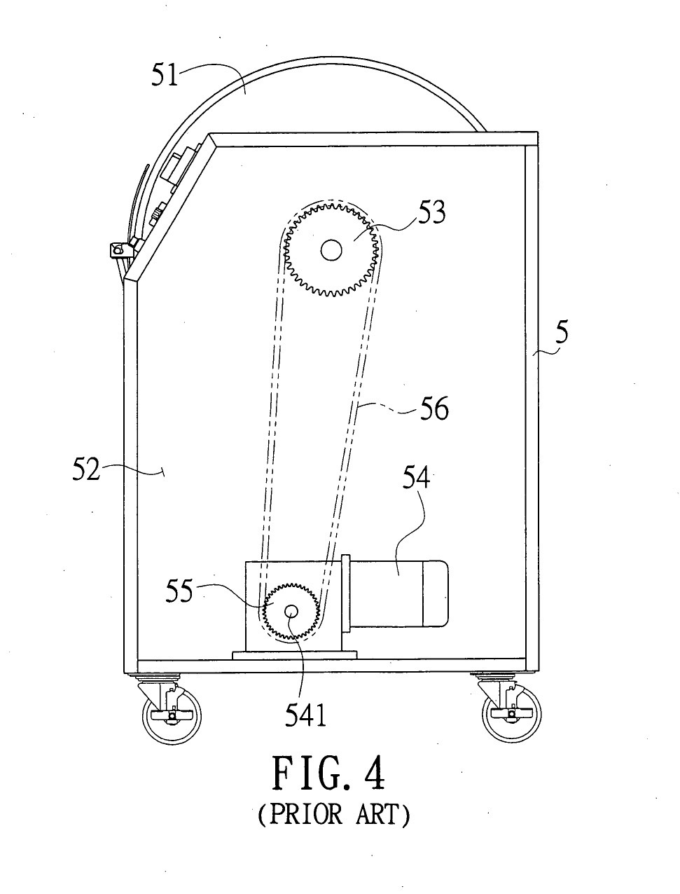

### DETAILED DESCRIPTION OF PREFERRED EMBODIMENTS

The objects, the technical contents and the expected effectiveness of the present invention will become more apparent from the detailed description of the preferred embodiment in conjunction with the accompanying drawings.

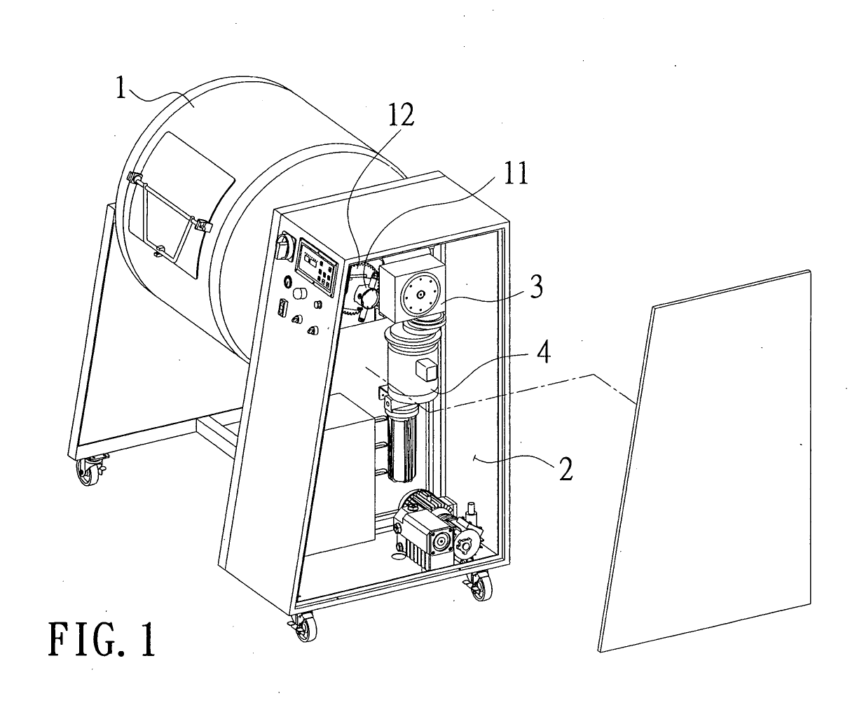

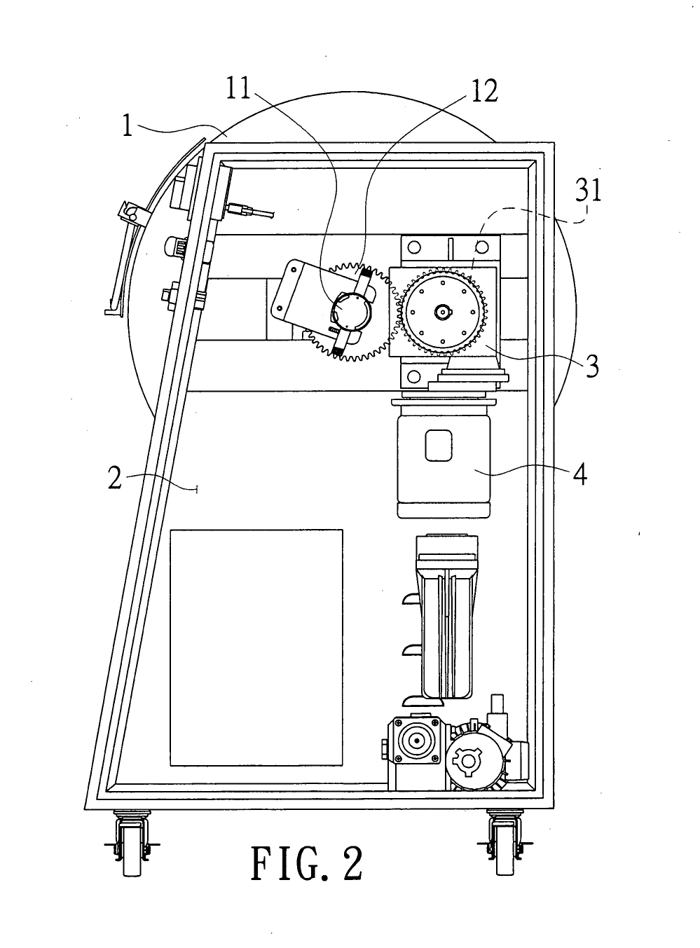

Firstly referring to FIGS. 1 and 2, a transmission structure of meat tumbler of the present invention is shown, in which one end of an axle (11) of a drum (1) extending toward a control box (2) is assembled with a gear (12), and a reduction machine (3) is installed in the control box (2). A gear (31) of the reduction machine (3) meshes with the gear (12) of the drum (1). A motor (4), preferably an inverter motor, coupled to the reduction machine (3) is provided within the control box (2).

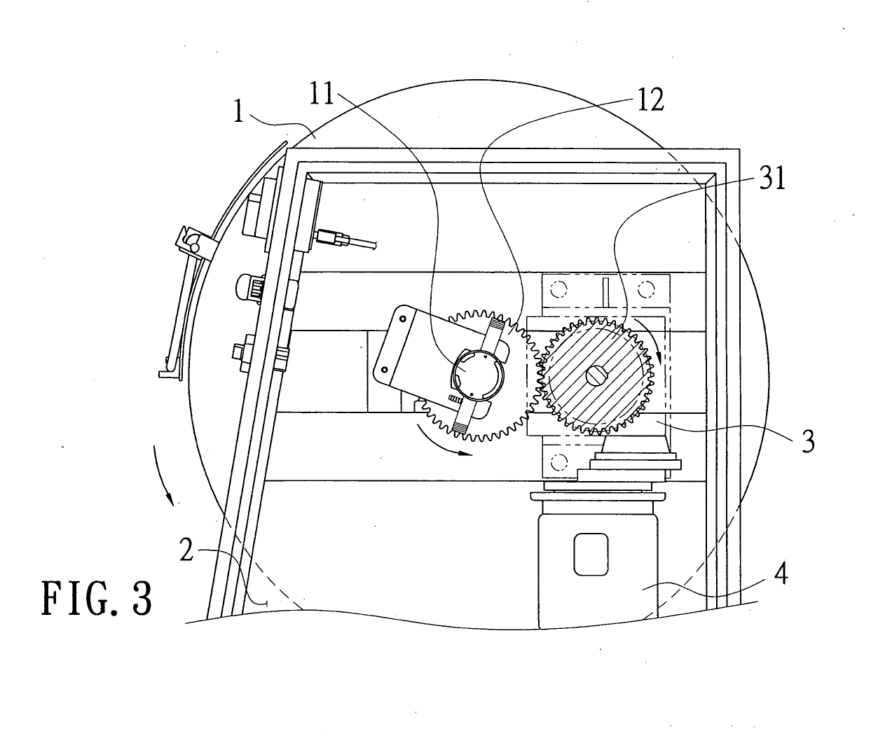

When in operation, as shown in FIGS. 1 to 3, the motor (4) drives the reduction machine (3) to rotate so that the gear (31) of the reduction machine (3) in turn meshes with the gear (12) of the drum (1) so as to cause the gear (12) and the drum (1) into rotation.

Accompanying with the rotation of the drum (1), meat product received in the drum (1) in advance is conducted with repeatedly raised and dropped actions. By the guiding of propeller blades mounted on the inner wall surface of the drum (1), meat product can get agitated and tumbled effect in reciprocating manner. Hence, meat product can get sufficient massage so that meat becomes fresh and delicious.

In operation of the transmission structure of meat tumbler of the present invention, the motor (4) directly drives the reduction machine (3), and in turn the gear (31) of the reduction machine (3) directly meshes with the gear (12) of the drum (1) to rotate. Therefore, significant noise is not produced, and power is fully transmitted without any improper loss, and stripping between transmission parts can be prevented in operation. In this manner, stability in operation of the transmission structure of meat tumbler of the present invention can be ensured so that maintenance cost can be reduced.

Based on the above structure and embodiment, the transmission structure of meat tumbler of the present invention has the following advantages.

1. In the transmission structure of meat tumbler of the present invention, a motor directly drives the reduction machine, and in turn a gear of the reduction machine directly meshes with a gear of the drum to rotate. Therefore, stable fitting state between parts can be maintained so as not to produce loose or stripping between parts.

2. In the transmission structure of meat tumbler of the present invention, a motor directly drives the reduction machine, and in turn a gear of the reduction machine directly meshes with a gear of the drum to rotate. Therefore, power can be fully transmitted without any improper power loss.

3. In the transmission structure of meat tumbler of the present invention, a motor directly drives the reduction machine, and in turn a gear of the reduction machine directly meshes with a gear of the drum to rotate. In this manner, quiet operation of the transmission structure of meat tumbler can be ensured so that a good environment of operation can be provided.

4. In the transmission structure of meat tumbler of the present invention, a motor directly drives the reduction machine, and in turn a gear of the reduction machine directly meshes with a gear of the drum to rotate. In this manner, stability in operation can be maintained so that maintenance cost can be reduced.

What is claimed is:

1. A transmission structure of meat tumbler, wherein one end of drum's axle, extending toward a control box, of the meat tumbler is assembled with a gear and a reduction machine is installed in the control box, a gear of the reduction machine meshing with the gear of the drum; a motor coupled to the reduction machine being provided within the control box.

2. A transmission structure of meat tumbler as claimed in claim 1, wherein said motor is an inverter motor.
